(19) United States
(12) Patent Application Publication
(10) Pub. No.: US 2023/0158714 A1
(43) Pub. Date: May 25, 2023

(54) TREATMENT OF A FIBRE REINFORCED COMPOSITE ELEMENT

(71) Applicant: Blade Dynamics LLLP, New Orleans, LA (US)

(72) Inventor: Fritz Andres CAMPO, New Orleans, LA (US)

(21) Appl. No.: 17/921,437

(22) PCT Filed: Apr. 27, 2021
(86) PCT No.: PCT/US2021/029321

§ 371 Date: Oct. 26, 2022

(30) Foreign Application Priority Data
Apr. 27, 2020 (GB) 2006134.7

(51) Int. Cl. B29B 13/08; B23K 26/06; B23K 26/352; B29C 70/54

(52) U.S. Cl. CPC B29B 13/08; B23K 26/0604; B23K 26/352; B29C 70/54; B23K 2103/16

(57) ABSTRACT

The disclosure relates to a method of manufacturing a fibre reinforced composite, wherein the surface of the fibre reinforced composite modified by using a laser radiation. In particular, the pre-treatment is performed before a bonding process. Time-consuming and dust generating grinding of the surface can be avoided.

The present disclosure relates to a method for pre-treating fibre reinforced composite elements. In particular, the disclosure relates to method for producing fibre reinforced composite structures, particularly wind turbine blades, or components thereof.

### BACKGROUND

For manufacturing wind turbines, in particular wind turbine blades, fibre reinforced carbon or glass fibre composite are used. As wind turbines and wind turbine blades increase in size, the blade loads, i.e. strains, bending moments, peel loads etc increase.

Reinforced composite materials help to manufacture lightweight structures which sustain high mechanical forces.

Laminate structures consist of a multitude of fibre layers bonded with a resin. The number of layers may change from area to area depending on the expected stresses in the respective area. The thickness of a fibre reinforced laminate may change over its length or width, e.g. a wind turbine blade tapers towards the tip with a very acute angle.

The boundaries of the individual layers can be problematic. In particular, undesired resin pools and/or air inclusions can occur.

In order to reduce this problem, document WO 2006/015598 A1 suggests using layers with tapered edge regions.

Many components, in particular wind turbine blades, may further consist of a multitude of semi-finished components which are bonded to each other.

In particular, pultruded fibre reinforced profiles are used as such semi-finished structural components.

In general, composite materials require surface preparation for performing further production steps, in particular machining, e.g. grinding.

This surface preparation is carried out at a very small scale, compared to the scale of area and volume needed to be treated. In the case of pultruded carbon components, less than 0.1 mm are removed from the surface to pre-treat the material.

Chamfers at the end of such a pultruded component require in the order of 1:100 chamfer angles with a desired 0.1 mm thickness left at the end of pultrusion, which can be 100 m long and 100 mm wide.

Similarly, for scarf joints or repairs, very flat angles are required to minimize the stresses, and to minimize the required properties that the adhesive can provide.

Currently, the pre-treating process is conducted by highly skilled technicians, which for example use grinding. This produces a non-homogeneous, dirty environment. In particular, the dust particles may be harmful. Furthermore, carbon particles may damage any electric equipment due to the electrical conductivity and due to the fact that such small particles are distributed in the entire area and also infiltrate most dust covers.

Due to the manual production, the result is a very variable and uncertain mechanical performance of the joined substrates.

### SUMMARY

It is an object of the present disclosure to provide an improved method for manufacturing fibre reinforced composite components and/or structures.

It is another object of the present disclosure to provide fibre reinforced composite elements, components and associated structures with improved mechanical properties.

The object of the disclosure is achieved by a method of manufacturing and/or pre-treating a fibre reinforced composite element and by a fibre reinforced composite element and/or component as disclosed herein.

The present disclosure relates to a method of pre-treating a fibre reinforced composite element. The method comprises: providing a first laser configured to emit a first laser beam in a first laser direction; orienting the fibre reinforced composite element relative to the first laser such that the first laser is at a first laser distance along the first laser direction from a first surface of the fibre reinforced composite element; emitting the first laser beam in the first laser direction from the first laser; and while emitting the first laser beam moving the fibre reinforced composite element in a primary direction relative to the first laser.

A laser described in the present disclosure may be embodied as a laser diode (LD).

The present disclosure provides that the surface of the fibre reinforced composite element may be modified by using a laser radiation.

The fibre reinforced composite element may be pre-treated before incorporating the fibre reinforced composite element in a fibre reinforced composite structure, such as wind turbine blade or a part thereof.

The fibre reinforced composite element is moved relative to the laser beam. In one example, the fibre reinforced composite element and not the laser is moved. However, according to another example, the laser(s) may be moved, e.g. while the fibre reinforced composite element may be held stationary. For example, moving the laser(s) may be advantageous for a pre-treatment in a mould for the fabrication of a wind turbine blade.

The fibre reinforced composite element may be embodied as a carbon or glass fibre element. For example, the fibre reinforced composite element may comprise carbon fibre and/or glass fibre.

In particular, the disclosure relates to the manufacturing of components of a wind turbine blade, in particular a wind turbine blade. A wind turbine blade typically comprises a root region, an airfoil region with a tip, a pressure side, a suction side and a chord line extending between a leading edge and a trailing edge. The blade may be manufactured by bonding two shells. Each shell part may comprise a core, e.g. a polymer foam, which is laminated with glass and/or carbon fibre layers which are embedded in a polymer resin. The core may not extend through the entire length of the wind turbine blade, in particular, a tip end region may only comprise fibre reinforced laminate.

By varying the thickness of composite elements, the mechanical properties can be adjusted according to the desired properties across the length and width of the structure. For example, the thickness of a composite element may be gradually reduced towards the tip of a wind turbine blade.

Prefabricated structural elements, e.g. pultruded elements, such as pultruded carbon or glass fibre elements may be used to form a component, such as a component of a structure, e.g. a wind turbine blade. For example, a spar cap of the wind turbine blade may be formed, at least in part, by pultruded elements. Accordingly, the fibre reinforced composite element may be a pultruded element, such as a pultruded carbon fibre or glass fibre element.

The fibre reinforced composite element may comprise a resin, e.g. epoxy, polyester, or vinyl ester resin. The fibre reinforced composite element may be a pultruded element comprising the resin.

In order to reduce mechanical stresses and/or in order to minimize the required mechanical properties of the bonding agent, flat angles between bonded components, in particular ramp angles of less than 10°, such as less than 5°, such as less than 1°, may be used.

The inventor discovered that by pre-treating the surface of a fibre reinforced composite with laser radiation, the surface can be prepared in a very efficient manner to perform further manufacturing steps.

The laser radiation can be used to remove material from the surface. In particular, mechanical grinding can be avoided.

This also avoids or at least reduces the formation of dust. The material to be removed is rather oxidized and/or evaporated. The resulting gases can be easily exhausted without forming dust particles on the component itself or in the adjacent area.

The laser radiation can also, e.g. simultaneously, be used to clean the surface and/or may be used to chemically re-activate parts of the surface, such as resin of the surface.

The primary direction may be parallel to the first surface. Hence, the laser may be moved relative to the surface of the fibre reinforced component at a constant distance. This may result in a homogeneous energy input into the first surface.

The fibre reinforced composite element may be oriented relative to the first laser such that the first laser direction is substantially perpendicular to the first surface.

Also disclosed is a method of manufacturing a fibre reinforced composite structure or a fibre reinforced composite component of the fibre reinforced composite structure. The method may comprise: providing a first fibre reinforced composite element; pre-treating the first fibre reinforced composite element according to the above; and after pre-treating the first fibre reinforced composite element incorporating the first fibre reinforced composite element in the fibre reinforced composite component/structure.

Incorporating the first fibre reinforced composite element in the component/structure, the method may comprise the step of applying a bonding agent to the first surface of the first fibre reinforced composite element.

A second fibre reinforced component may be provided. The method may comprise pre-treating the second fibre reinforced composite element according to the above.

The first surface of the first fibre reinforced composite element may be joined with a first surface of the second fibre reinforced composite element, e.g. and applying a bonding agent between the first surface of the first fibre reinforced composite element and the first surface of the second fibre reinforced composite element.

The disclosed pre-treatment with laser radiation may be used before wetting the surface with a bonding agent and/or before bonding the pre-treated element with another element, in particular to another fibre reinforced composite element.

It has been discovered that the pre-treatment with laser radiation results in an increased wetting when applying a bonding agent. In particular, in comparison with an untreated fibre reinforced composite, the contact angle of a drop of bonding agent was found to be reduced by at least 10°. Thus, the bonding agent may penetrate the surface quicker without forming undesired resin pools on the surface.

Exemplary bonding agents may be polyester resins, vinyl ester resins, epoxy resins etc. The bonding agent may be the same as the resin of the fibre reinforced composite element(s).

The modified surface of the fibre reinforced composite element can be bonded to another element, in particular to another fibre reinforced composite element, e.g. in a vacuum infusion process, e.g. vacuum assisted resin transfer moulding (VARTM).

In a VARTM process, the elements are laid into a mould and enclosed in a bagging material. Then, the bag is subjected to vacuum pressure. Once the air has been removed from the bag and the reinforcement has been fully compressed under this pressure, liquid resin is introduced which then infuses through the reinforcement structure under the vacuum pressure. Once the resin has fully infused through the reinforcement, the supply of resin is stopped and the resin is left to cure, preferably still under vacuum pressure.

By using laser radiation, the surface can be structured, roughened, cleaned and/or chemically activated. The first laser and/or the first laser distance may be configured such that the first surface of the fibre reinforced composite element is modified, e.g. structured, roughened, cleaned and/or chemically activated, by the first laser beam hitting the first surface.

According to a preferred embodiment, the surface may be modified by applying the laser radiation in a multitude of parallel stripes onto a contiguous area.

In particular, a multitude of focused lasers beams is moved in relation to the surface. In particular, a pultruded fibre reinforced composite element can be conveyed across a treatment zone comprising at least one row of laser emitters.

Thereby large surface areas may be pre-treated quickly.

The stripes can be applied adjacently to each other and/or overlappingly each other, e.g. resulting in a pre-treated surface area without any undesired gaps.

According to an embodiment, the surface may be modified in the form of a grid consisting of pre-treated stripes. In particular, the stripes may be embodied as grooves.

The fibre reinforced composite element may be pre-treated by passing a multitude of laser beams. For example, an array of LDs may be used to provide such a multitude of laser beams.

According to an embodiment, a laser array may be used, which comprises a plurality of lasers including the first laser and a second laser. The second laser may be configured to emit a second laser beam in a second laser direction. The fibre reinforced composite element may be oriented relative to the second laser such that the second laser is at a second laser distance along the second laser direction from the first surface of the fibre reinforced composite element. The method of pre-treating the fibre reinforced composite element may comprise emitting the second laser beam in the second laser direction from the second laser. The first laser direction and the second laser direction may be parallel. The first laser and the second laser may be separated along the primary direction and located along a line non-parallel with the primary direction.

The surface of the fibre reinforced composite element may be moved relative to the array of lasers and may be subjected by stripes which are generated by the laser beams, which are focused onto to the moving surface.

The laser beams may be arranged parallel with respect to each other.

Since each laser beam focused onto the surface has a Gaussian distribution of intensity, a modified area with the appearance of a raked or brushed surface may be generated. For example, the pre-treated surface may comprise a multitude of grooves being arranged substantially parallel to each other.

The roughness of the modified surface may be increased by the laser treatment. In particular, the modified surface may have a roughness Ra of more than 0.05 mm, preferably more than 0.1 mm.

The laser treatment stripes may be arranged substantially in the direction of the fibres of the fibre reinforced composite element. It was found that cracks in the fibres may be reduced or avoided by moving the laser beams in the direction of fibres or in an acute angle across the fibre. Accordingly, the movement of the fibre reinforced composite element relative to the first laser and/or second laser in the primary direction may be substantially parallel with the orientation of the fibres of the fibre reinforced composite element, e.g. the fibres of the fibre reinforced composite element may be substantially oriented along the primary direction.

The fibre reinforced composite element may comprise substantially unidirectional fibres, e.g. along the length of the fibre reinforced composite element. Alternatively, the fibre reinforced composite element may comprise multiaxial fibre directions, e.g. the fibre reinforced composite element may comprise biaxial fibre orientations and/or triaxial fibre orientations. In case of the fibre reinforced composite element comprising multiaxial fibre directions, the laser treatment may be synchronised, e.g. by turning on and off the first laser and/or the second laser, with the positions of the transversal fibre rowings, such as to avoid or reduce damaging fibres caused by moving the laser beam in a direction across the fibres.

In a non-woven multiaxial fibre layer, fibres arranged along a plurality of axes are arranged in sub-layers, wherein each sub-layer comprises fibres arranged in a single direction, the sub-layers are arranged on top of each other and held in place, typically by polyester threads. In case of treating a non-woven multiaxial fibre layer, e.g. the fibre reinforced composite element may comprise a non-woven multiaxial fibre layer at the first surface (e.g. immediately below a thin layer of cured resin), the primary direction may be substantially parallel with the orientation of the fibres of the layer of the multiaxial fibre layer closest to the first surface.

A laser with a wavelength between 230 and 500 nm may be used, such as a wavelength between 400 and 500 nm, such as a wavelength between 450 to 460 nm. This wavelength was found to be advantageous for the resins used for carbon and glass fibre elements.

The surface, e.g. the first surface, may be modified by subjecting the surface with a power density of more than 1 MW/cm², such as more than 10 MW/cm², such as more than 15 MW/cm². The surface may be modified by subjecting the surface with a power density of less than 100 MW/cm², such as less than 60 MW/cm².

The surface of the fibre reinforced composite may be modified by subjecting the surface with an energy density, e.g. of the laser radiation, of more than 80 J/cm², such as more than 100 J/cm², such as more than 200 J/cm². The energy density may be kept below 1000 J/cm².

The desired penetration depth of the laser pre-treatment can be adjusted by modifying the power density and the movement of the fibre reinforced composite element relative to the laser beam.

Material of the surface may be removed to maximum depth of 0.05 mm to 2 mm, such as to a maximum depth of 0.1 to 1 mm.

A pulsed laser radiation may be used. The laser radiation may be pulsed. A pulsed laser radiation facilitates the adjustment of the power density. For example, the power density can be controlled by adjusting a pulse width and/or repetition rate of the pulsed laser radiation. In particular pulse frequencies between 10 and 100 kHz, e.g., between 20 and 200 kHz can be used.

Alternatively, or additionally, the power density (and thereby the energy density) may also be adjusted by using LDs with a different focal length and/or by adjusting the spot size which is dependent from the distance of the lens from the surface. For example, LDs comprising a lens with a focal length between 10 and 100 mm, e.g. between 20 and 80 mm, can be used. A spot size on the fibre reinforced composite elements may be between 1 and 5 mm, preferably between 2 and 3 mm.

The present disclosure also relates to a fibre reinforced composite element and a fibre reinforced composite structure, e.g. a fibre reinforced composite structure of a wind turbine blade, being manufactured by using a method as described.

In particular, the fibre reinforced composite structure comprises at least one surface which is bonded to another surface and which comprises a multitude of stripes being formed by laser radiation.

The disclosure further relates to an arrangement for pre-treating a fibre reinforced composite element, e.g. according to the above disclosure. For example, the arrangement may comprise an array of lasers being arranged in lines and columns, wherein a column with at least one laser is arranged offset with respect to the following column with at least one laser.

The arrangement may comprise a plurality of lasers including a first laser and a second laser, wherein the first laser is adapted to emit the first laser beam in the first laser direction, and the second laser is adapted to emit the second laser beam in the second laser direction. The arrangement may be adapted to be oriented relative to the fibre reinforced composite element such that the first laser is at the first laser distance along the first laser direction from the first surface of the fibre reinforced composite element and such that the second laser is at the second laser distance along the second laser direction from the first surface of the fibre reinforced composite element.

While emitting the first laser beam and the second laser beam the arrangement may be adapted to move relative to the fibre reinforced composite element along the primary direction. The first laser and the second laser may be separated along the primary direction and located along a line non-parallel with the primary direction.

With such a pre-treatment device, large surface areas can be processed quickly. Due to the offset of the columns with respect to each other, a broad area can be subjected by laser radiation in one single step.

In order to pre-treat a large area in one single step, the fibre reinforced composite element can also be moved in relation to a laser array being inclined with an acute angle with respect to the array, in particular with an angle between 0.5° to 10°, preferably between 1° and 2°.

The relative movement of the fibre reinforced composite element and the arrangement and/or the first laser and/or the second laser may be at a speed of more than 0.1 m/s, such as more than 0.2 m/s.

The arrangement, such as the array of lasers of the arrangement, may comprise more than 50 lasers, such as more than 1000 lasers.

It is an advantage of the present disclosure that it provides a repeatable, clean process with the possibility of a surface modification method to prepare composite materials in an industrial environment, or repair scenario.

The pre-treatment arrangement could be portable depending on the application.

The movement of the fibre reinforced composite element in the primary direction relative to the first laser, the second laser and/or the plurality of lasers may be effected by movement of the fibre reinforced composite element while the first laser, the second laser and/or the plurality of lasers are held stationary. Alternatively, the movement of the fibre reinforced composite element in the primary direction relative to the first laser, the second laser and/or the plurality of lasers may be effected by movement of the first laser, the second laser and/or the plurality of lasers while the fibre reinforced composite element is held stationary. Alternatively, the movement of the fibre reinforced composite element in the primary direction relative to the first laser, the second laser and/or the plurality of lasers may be effected by a combined movement of the fibre reinforced composite element and the first laser, the second laser and/or the plurality of lasers.

### BRIEF DESCRIPTION OF THE FIGURES

Embodiments of the disclosure will be described in more detail in the following with regard to the accompanying figures. The figures show one way of implementing the present disclosure and are not to be construed as being limiting to other possible embodiments falling within the scope of the attached claim set.

FIG. 1 is schematic illustration of a fibre reinforced composite element being pre-treated with laser radiation,

FIG. 2 is a schematic illustration of a laser module,

FIG. 3 is a schematic illustration of a pultruded fibre reinforced profile being pre-treated with laser radiation by using an array of laser modules,

FIG. 4 is a picture of an exemplary pre-treated surface,

FIG. 5 is a picture of an exemplary surface with a pre-treated area, and resin applied to the surface, and

FIG. 6 shows exemplary depth profiles of a surface being pre-treated with laser radiation of varying power density.

### DETAILED DESCRIPTION

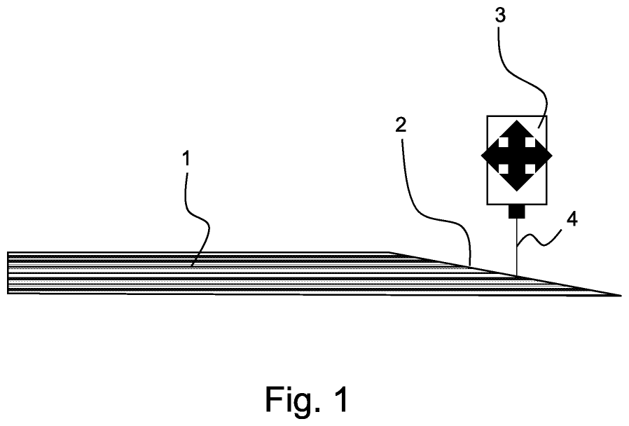

FIG. 1 is schematic illustration of a fibre reinforced composite element 1 being pre-treated with laser radiation.

The fibre reinforced composite element 1 may be embodied as a pultruded carbon profile, wherein the thickness is reduced towards at least one edge, resulting in a very shallow angle.

The fibre reinforced composite element 1 may be pre-treated before the component is bonded, e.g. in an infusion bonding process, to another component.

The surface 2 of the fibre reinforced composite element may be pre-treated with laser radiation.

In the illustrated example, a single laser 3 is moved so that the laser beam 4, which is focused onto the surface, moves over the surface 2 in a meandering fashion. Preferably, the laser 3 is moved parallel to the surface 2 in order to ensure a constant distance from the surface 2. The laser beam 4 is aligned substantially perpendicular to the surface 2.

The laser 3 forms a multitude of grooves on the surface, which may overlap or border directly on each other in order to pre-treat the entire desired surface area. The result may be a peeled surface region.

Since generation of dust particles may be reduced or avoided, the fibre reinforced composite element can be used directly for further manufacturing steps, in particular for an infusion bonding process.

For pre-treating larger elements, the process may be scaled up. For scaling up the process, an array of lasers, e.g. LDs, may be used.

Lasers with a maximum power output of more than 2 W, such as more than 10 W, may be suitable to emit a focused beam onto the surface having a power density of more than 2 MW/cm².

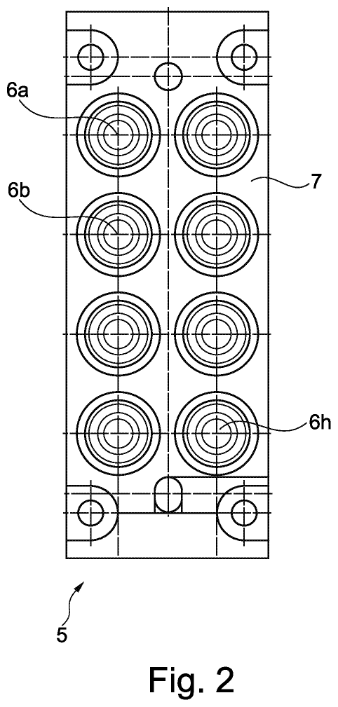

FIG. 2 schematically illustrates a laser module 5 which comprises a multitude of lasers which are arranged on a support 7, e.g. a circuit board.

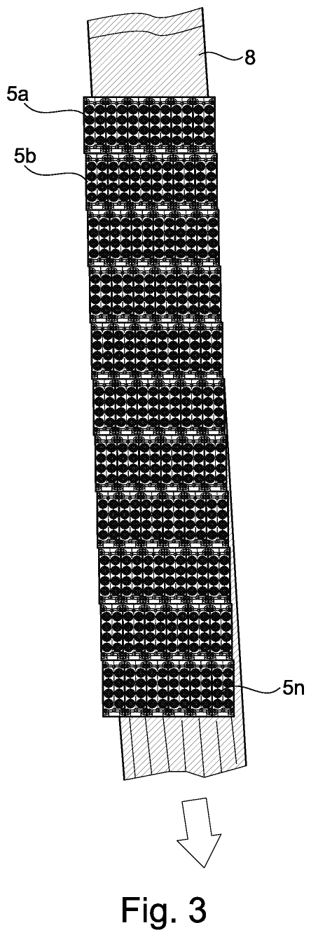

As illustrated in FIG. 3, which is a schematic illustration of a fibre reinforced composite element, such as a pultruded fibre reinforced composite element 8 being pre-treated with laser radiation by using an array of laser modules, a multitude of laser modules 5a-5n may be used, e.g. to pre-treat a large area in a short time.

In the illustrated example, the laser modules 5a-5n and the lasers themselves form an array, wherein modules and the lasers are arranged in rows and columns.

According to this embodiment, the lasers of one row of laser modules are arranged offset to the lasers of the adjacent row (e.g. 5b to 5a). Preferably, the offset distance is 0,5 to 5 of the spot size of the focused beam on the surface. Thereby, it is possible to pre-treat the entire surface of the fibre reinforced composite element in one process, i.e. by moving the fibre reinforced composite element through the arrangement of lasers once. This can also or in addition be achieved by inclining the fibre reinforced composite element with respect to the LD array in an acute angle.

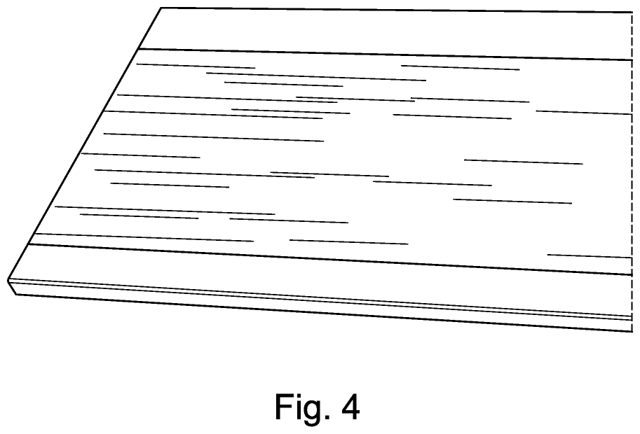

FIG. 4 is a picture of a pre-treated surface. The surface comprises a multitude of essentially parallel arranged grooves with a width between 0.1 and 1.5 mm and/or a maximum depth between 0.05 and 1 mm, which are generated by the laser radiation.

The surface is “brushed” by the laser radiation and has the appearance of a brushed metal surface.

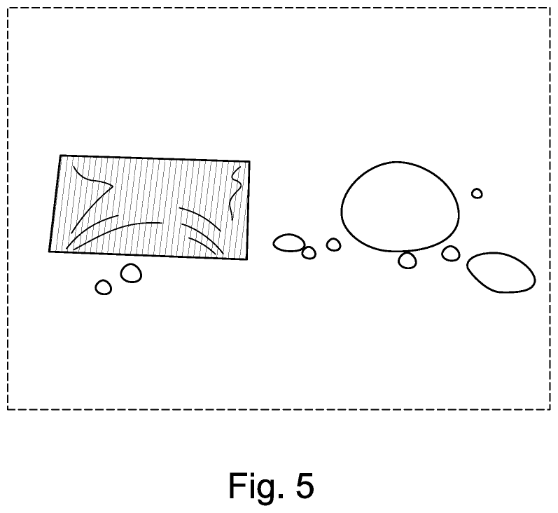

FIG. 5 is a picture of surface with a pre-treated area, wherein a resin is applied to the surface, i.e. onto the treated as well as onto an untreated area.

On the untreated area, the resin forms a drop with a contact angle of more than 40°. In contrast, the resin forms a shallow wetted area on the rectangular pre-treated region, with a much smaller contact angle. As seen the treatment causes a much better wetting of the element by the resin, compared to an untreated element.

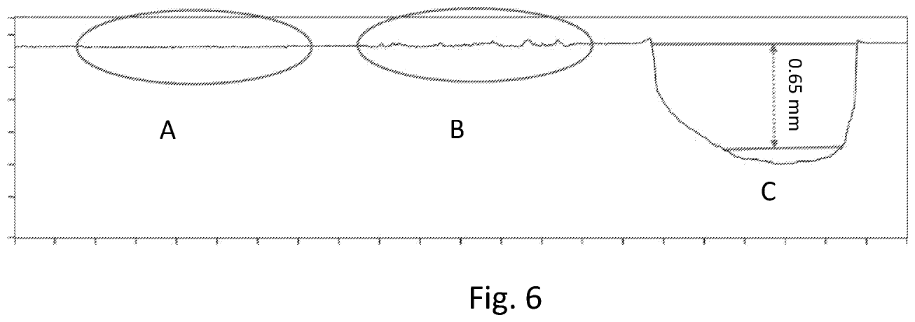

FIG. 6 shows exemplary depth profiles of a surface being pre-treated with laser radiation of varying power density.

In area A, the surface has been exposed to a pulsed laser radiation with a power density of less than 2 MW/cm² and with an energy of 115 J/cm². Surface area A is slightly roughened.

Surface area B has been treated with by a pulsed laser radiation with a power density of approx. 3 MW/cm², resulting in an energy of 160 J/cm². This results in a rougher surface in comparison to area A.

As shown in area C, a pulsed laser radiation with a power density of approx. 8.5 MW/cm², resulting in an energy of 220 J/cm², generates grooves with a maximum depth of more than 0.5 mm.

The disclosure has been described with reference to preferred embodiments. However, the scope of the invention is not limited to the illustrated embodiments, and alterations and modifications can be carried out without deviating from the scope of the invention.

Exemplary embodiments of the present disclosure are provided in the following items:

1. A method of pre-treating a fibre reinforced composite element, the method comprising:
providing a first laser configured to emit a first laser beam in a first laser direction;
orienting the fibre reinforced composite element relative to the first laser such that the first laser is at a first laser distance along the first laser direction from a first surface of the fibre reinforced composite element;
emitting the first laser beam in the first laser direction from the first laser;
while emitting the first laser beam moving the fibre reinforced composite element relative to the first laser in a primary direction.

2. Method according to item 1, wherein the fibre reinforced composite element is pre-treated before incorporating the fibre reinforced composite element in a fibre reinforced composite structure.

3. Method according to any of the preceding items, wherein the primary direction is parallel to the first surface.

4. Method according to any of the preceding items, wherein the fibre reinforced composite element is oriented relative to the first laser such that the first laser direction is substantially perpendicular to the first surface.

5. Method according to any of the preceding items, wherein the fibre reinforced composite element is a pultruded element.

6. Method according to any of the preceding items, wherein the fibre reinforced composite element comprises carbon fibre and/or glass fibre.

7. Method according to any of the preceding items, wherein the fibre reinforced composite element comprises a resin, e.g. epoxy, polyester, or vinyl ester resin.

8. Method according to any of the preceding items, wherein fibres of the fibre reinforced composite element is substantially oriented along the primary direction.

9. Method according to any of the preceding items, wherein the first laser and the first laser distance are configured such that the first surface of the fibre reinforced composite element is modified, e.g. structured, roughened, cleaned and/or chemically activated, by the first laser beam hitting the first surface.

10. Method according to any of the preceding items, wherein the first surface of the fibre reinforced composite element is subjected with a power density of more than 1 MW/cm2, such as more than 10 MW/cm2, such as more than 15 MW/cm2 and/or wherein the first surface of the fibre reinforced composite element is subjected with a power density of less than 100 MW/cm2, such as less than 60 MW/cm2.

11. Method according to any of the preceding items, wherein the first surface of the fibre reinforced composite element is subjected with an energy of more than 80 J/cm2, such as more than 100 J/cm2, such as more than 200 J/cm2 and/or wherein the first surface of the fibre reinforced composite element is subjected with an energy of less than 1000 J/cm2.

12. Method according to any of the preceding items, wherein the first laser beam has a wavelength between 400 and 500 nm.

13. Method according to any of the preceding items, wherein the laser radiation is pulsed, and wherein the power density is controlled by adjusting a pulse width and/or repetition rate of the pulsed laser radiation.

14. Method according to any of the preceding items comprising providing a plurality of lasers including the first laser and a second laser, wherein the second laser is configured to emit a second laser beam in a second laser direction, and wherein orienting the fibre reinforced composite element comprise orienting the fibre reinforced composite element relative to the second laser such that the second laser is at a second laser distance along the second laser direction from the first surface of the fibre reinforced composite element, and the method comprises emitting the second laser beam in the second laser direction from the second laser.

15. Method according to item 14, wherein the first laser direction and the second laser direction are parallel.

16. Method according to any of items 14-15, wherein the first laser and the second laser are separated along the primary direction and located along a line non-parallel with the primary direction.

17. A method of manufacturing a fibre reinforced composite structure, the method comprising:
providing a first fibre reinforced composite element;
pre-treating the first fibre reinforced composite element according to any of the preceding items;
after pre-treating the first fibre reinforced composite element incorporating the first fibre reinforced composite element in the fibre reinforced composite structure.

18. Method according to item 17, wherein incorporating the first fibre reinforced composite element comprises applying a bonding agent to the first surface of the first fibre reinforced composite element.

19. Method according to any of items 17 or 18 comprising providing a second fibre reinforced composite element.

20. Method according to item 19 comprising pre-treating the second fibre reinforced composite element according to any of the preceding items.

21. Method according to any of items 17 or 18, wherein incorporating the first fibre reinforced composite element comprises joining the first surface of the first fibre reinforced composite element and the first surface of the second fibre reinforced composite element and applying a bonding agent between the first surface of the first fibre reinforced composite element and the first surface of the second fibre reinforced composite element.

22. Method according to any of the preceding items, wherein the fibre reinforced composite structure is a wind turbine blade or a part thereof

23. A fibre reinforced composite structure, e.g. a fibre reinforced composite structure of a wind turbine blade, being manufactured using a method according to any of items 17-22.

24. A fibre reinforced composite element comprising at least one surface, which is pre-treated with laser radiation by the method according to any of items 1 to 16.

25. Arrangement for pre-treating a fibre reinforced composite element, the arrangement comprising a plurality of lasers including a first laser and a second laser, wherein the first laser is adapted to emit a first laser beam in a first laser direction, and the second laser is adapted to emit a second laser beam in a second laser direction,

the arrangement being adapted to be oriented relative to the fibre reinforced composite element such that the first laser is at a first laser distance along the first laser direction from a first surface of the fibre reinforced composite element and such that the second laser is at a second laser distance along the second laser direction from the first surface of the fibre reinforced composite element,

while emitting the first laser beam and the second laser beam the arrangement is adapted to move relative to the fibre reinforced composite element along a primary direction,

wherein the first laser and the second laser are separated along the primary direction and located along a line non-parallel with the primary direction.

1-23. (canceled)

24. A method of pre-treating a fiber reinforced composite element, the method comprising:
providing a plurality of lasers including a first laser and a second laser, wherein the first laser is configured to emit a first laser beam in a first laser direction and the second laser is configured to emit a second laser beam in a second laser direction, and wherein the first laser and the second laser are separated along a primary direction and located along a line non-parallel with the primary direction;
orienting the fiber reinforced composite element relative to the plurality of lasers such that the first laser is at a first laser distance along the first laser direction from a first surface of the fiber reinforced composite element and the second laser is at a second laser distance along the second laser direction from the first surface of the fiber reinforced composite element;
emitting the first laser beam in the first laser direction from the first laser;
emitting the second laser beam in the second laser direction from the second laser; and
while emitting the first laser beam and the second laser beam, moving the fiber reinforced composite element relative to the first laser and the second laser in the primary direction.

25. The method of claim 24, wherein the fiber reinforced composite element is a first fiber reinforced composite element, the method further comprising:
pre-treating the first fiber reinforced composite element; and
subsequently incorporating the first fiber reinforced composite element in a fiber reinforced composite structure.

26. Method according to claim 25, wherein incorporating the first fiber reinforced composite element comprises applying a bonding agent to a first surface of the first fiber reinforced composite element.

27. The method of claim 26, further comprising:
providing a second fiber reinforced composite element;
pre-treating the second fiber reinforced composite element; and
subsequently incorporating the second fiber reinforced composite element in the fiber reinforced composite structure.

28. The method of claim 27, wherein incorporating the first fiber reinforced composite element comprises joining the first surface of the first fiber reinforced composite element and a first surface of the second fiber reinforced composite element and applying a bonding agent between the first surface of the first fiber reinforced composite element and the first surface of the second fiber reinforced composite element.

29. The method of claim 24, wherein the primary direction is parallel to the first surface.

30. The method of claim 24, wherein the fiber reinforced composite element is oriented relative to the first laser such that the first laser direction is substantially perpendicular to the first surface.

31. The method of claim 24, wherein the fiber reinforced composite element is a pultruded element.

32. The method of claim 24, wherein the fiber reinforced composite element comprises at least one of carbon fiber or glass fiber.

33. The method of claim 24, wherein the fiber reinforced composite element comprises at least one of epoxy, polyester, or vinyl ester resin.

34. The method of claim 24, wherein fibers of the fiber reinforced composite element are substantially oriented along the primary direction.

35. The method of claim 24, wherein the first laser and the first laser distance are configured such that the first surface of the fiber reinforced composite element is modified by the first laser beam hitting the first surface.

36. The method of claim 24, wherein the first surface of the fiber reinforced composite element is subjected with a power density of more than 1 MW/cm² and less than 100 MW/cm².

37. The method of claim 33, further comprising pulsing laser radiation onto the fiber reinforced composite element, wherein the power density is controlled by adjusting at least one of a pulse width or a repetition rate of the pulsed laser radiation.

38. The method of claim 24, wherein the first surface of the fiber reinforced composite element is subjected with an energy of more than 80 J/cm² and less than 1000 J/cm².

39. The method of claim 24, wherein the first laser beam has a wavelength between about 400 nanometers (nm) and 500 nm.

40. The method of claim 24, wherein the first laser direction and the second laser direction are parallel.

41. The method of claim 24, wherein the fiber reinforced composite structure is a wind turbine blade or a part thereof.

42. An arrangement for pre-treating a fiber reinforced composite element, the arrangement comprising:
a plurality of lasers comprising a first laser and a second laser, the first laser adapted to emit a first laser beam in a first laser direction, the second laser adapted to emit a second laser beam in a second laser direction,
the arrangement adapted to be oriented relative to the fiber reinforced composite element such that the first laser is at a first laser distance along the first laser direction from a first surface of the fiber reinforced composite element and the second laser is at a second laser distance along the second laser direction from the first surface of the fiber reinforced composite element,
while emitting the first laser beam and the second laser beam, the arrangement is adapted to move the first laser and the second laser relative to the fiber reinforced composite element along a primary direction,
wherein the first laser and the second laser are separated along the primary direction and located along a line non-parallel with the primary direction.
